(19) United States
(12) Patent Application Publication
(10) Pub. No.: US 2026/0328678 A1
(43) Pub. Date: Oct. 22, 2026

(54) METHOD AND SYSTEM FOR ANALYZING OBJECTS

(71) Applicant: STEINERT GMBH, Köln (DE)

(72) Inventors: Uwe HABICH, Köln (DE); Jochen SCHÄFER, Wassenberg (DE); Stefan HEINRICHS, Köln (DE); Sebastian LANGE, Köln (DE); Dirk KILLMANN, Brühl (DE); Andreas ROPER YEARWOOD, Köln (DE); Porfirio Jesus MARIN MORALES, Bornheim (DE)

(21) Appl. No.: 19/107,741

(22) PCT Filed: Aug. 23, 2023
(86) PCT No.: PCT/EP2023/073140

§ 371 Date: Feb. 28, 2025

(30) Foreign Application Priority Data
Aug. 30, 2022 (DE) 10 2022 121 928.3
Aug. 30, 2022 (DE) 10 2022 121 929.1

(51) Int. Cl. B07C 5/342; B07C 5/36; G01N 21/31

(52) U.S. Cl. CPC B07C 5/342; B07C 5/368; G01N 21/31; G01N 2201/06113; G01N 2201/0833

(57) ABSTRACT

A system for analyzing objects has at least one feeding device, at least one analysis laser, and at least one spectrometer. The objects are cast off from an end of the feeding device to move on a trajectory for their analysis. The analysis laser generates a laser beam with a focal point. The analysis laser is directed toward the feeding device such that each object flies through the laser beam in the region of the focal point as it moves on its trajectory. A field of view of the spectrometer is directed at a region of the trajectory of the objects. The field of view of the spectrometer is realized by an open fiber end of an optical fiber to improve the analysis of the objects for correctly determining the material of the objects with a high degree of certainty.

The invention relates to a method for analyzing objects having the features of the preamble of patent claim 1 and a system for analyzing objects having the features of the preamble of patent claim 16.

Methods and systems of this type for analyzing and in particular also for sorting objects are used for example in particular during the recycling of objects. The objects to be analyzed and/or to be sorted may be in particular metal parts, metal scrap, in particular aluminum scrap, lumps of ore, batteries, packagings, waste or the like.

A corresponding method and a system of this type for analyzing objects is known from EP 3 352 919B1. The objects leave a feeding means embodied as a chute on a corresponding trajectory and during flight are analyzed and also correspondingly sorted on the basis of the analysis. For the analysis, an analysis laser and a spectrometer are arranged below the trajectory. Furthermore, a “pre-cleaning laser” (ablation laser) is provided for correspondingly cleaning the objects before the analysis. The analysis laser and the pre-cleaning laser are arranged parallel or at an angle to one another. The emission of the plasma generated at the object, said emission being generated by means of the pre-cleaning laser, is not detectable by means of the spectrometer. A separating plate is arranged between the two lasers and in particular also between the pre-cleaning laser and the spectrometer, such that possible emissions initiated at the object by the pre-cleaning laser are intercepted by the separating plate before they can reach the spectrometer. The pre-cleaning laser thus merely serves for pre-cleaning or ablation of the object. By contrast, the emission of the plasma generated at the object by means of the analysis laser is detectable by means of the spectrometer and is evaluated for the analysis of the object. The plasma generated by means of the analysis laser is generated at the object locations that have been pre-cleaned by means of the pre-cleaning laser, such that the object itself or the material of this object rather than possible contaminations of the object is analyzed by means of the spectrometer. To put it another way, it may be stated that a focal point of the analysis laser lies in a field of view of the spectrometer, but a focal point of the pre-cleaning laser lies outside the field of view of the spectrometer. The analysis laser in that case has a pulse repetition rate of 50 kHz or more. In the event of each laser pulse of the analysis laser, in order to generate the plasma at a measurement point an impact crater is produced at the object. At the high pulse repetition rate mentioned, overlaps of at least two impact craters may occur. Two successive laser pulses then impinge on the object at least partly in an identical region of the object. In the case of the device known here in the prior art, the feeding means has a plurality of feeding tracks, wherein each feeding track is assigned a laser or a respective blowing-out nozzle, wherein the blowing-out nozzles are formed in a so-called nozzle strip.

The known method or system described previously is still not configured optimally. The known spectrometer here has an imaging optical unit, through which the emissions or the radiation then enter(s) the spectrometer. On account of the imaging optical unit, the spectrometer has a limited, small field of view, such that inaccuracies in the adjustment of the spectrometer may already lead to considerable functional disturbances of the spectrometer. Furthermore, so-called chromatic “aberrations” occur at a collimator of the imaging optical unit, in which case emissions of different wavelengths are refracted to different extents but the collimator cannot be focused “sharply” for every wavelength at the same time. That in turn leads to problems in the evaluation of the measurement results of the spectrometer, such that the respective material of the respective object to be analyzed, under certain circumstances, then cannot be correctly determined or is affected by corresponding fault tolerances. Therefore, the invention addresses the problem of now configuring and/or developing the known method and/or the known system for analyzing objects in such a way that an analysis of the objects is improved, wherein in particular the material of the objects is determined or is determinable correctly with higher certainty, in particular possible higher costs are also avoided. This problem addressed by the invention is now solved firstly by a method for analyzing objects having the features of patent claim 1. The essential aspect of the invention now firstly essentially resides in the field of view of the spectrometer being realized by an open fiber end of an optical fiber. Such an open fiber end is firstly producible particularly simply, in particular also producible cost-effectively. Furthermore, the open fiber end, in particular compared with the use of a known collimator, is less sensitive to inaccuracies in the adjustment of the spectrometer, since the open fiber end has a significantly larger field of view compared with the use of a collimator. Furthermore, by means of the now open fiber end, the chromatic “aberrations” occurring at a collimator can be successfully avoided since, by means of the open fiber end, emissions of different wavelengths are captured with the same ratios of the intensities with which they are emitted by the plasma. This is furthermore very advantageous if the intensity captured by the open fiber end fluctuates owing to the possible different distances between the plasmas and the open fiber end. This last cannot be avoided on account of the in some instances complex geometries of the objects. However, with the use of an open fiber end (without a collimator being provided) the different intensities can then be captured unambiguously, in particular without corruption of the intensity ratios, and/or then as well can be assigned to the different distances. The open fiber end is in particular also positioned so near the trajectory of the objects that the emissions can reach the open fiber end with sufficiently high intensity for an accurate measurement. The emissions of the plasmas generated at the objects by the analysis laser are therefore captured by means of the open fiber end. The open fiber end is therefore less sensitive to adjustment than a collimator, the exact identical setting of which for a plurality of feeding tracks/measurement tracks is extremely problematic. The field of view of the open fiber end without a lens is in particular large enough to completely detect a plasma, even if the position of the plasma changes somewhat as a result of the surface shape of the object.

Generation of the plasmas gives rise to radiation, in particular electromagnetic radiation, in particular light having/of specific wavelengths, the respective wavelength and/or the intensity spectrum each being characteristic of the respective material of the respective objects. Proceeding from the plasmas ultimately for the analysis the radiation finally reaches the spectrometer or the sensors of the spectrometer. This radiation, in particular electromagnetic radiation, in particular the corresponding light having the respective wavelengths, is also referred to here as “the emission/the emissions” of the plasmas. The respective material of the objects can then be determined by this means.

The emissions of the plasmas are transmitted in the form of electromagnetic radiation from the plasmas firstly to the open fiber end, therefore. The emissions or the radiation are or is incoupled into the optical fiber at the open fiber end. To put it another way, the emissions or the radiation enter(s) the optical fiber directly at the open fiber end. By means of the optical fiber, the emissions or the radiation are or is then passed on to a sensor of the spectrometer, wherein the emissions or the radiation are or is then convertible here into electrical signals by means of the sensor or sensors.

In a further embodiment or configuration of the method, a second laser beam with a second focal point is generated with the aid of a second laser, wherein the second laser has been aligned and/or is aligned with the feeding means in such a way that the objects fly through the second laser beam in the region of the second focal point during their respective movement on their respective trajectory.

The second laser is configured and/or embodied in particular as a second analysis laser or as an ablation laser or is then used accordingly in that way.

For the case where the second laser is configured as an analysis laser, the second focal point of the second analysis laser lies in particular also in the field of view of the spectrometer or here then in the field of view formed by the open fiber end of the optical fiber. The first analysis laser and the second analysis laser have been or are then aligned with one another in such a way that the first focal point of the first analysis laser is spaced apart from the second focal point of the second analysis laser, wherein plasmas of the objects are generated by means of the first focal point of the first analysis laser and/or by means of the second focal point of the second analysis laser, and wherein the emissions of said plasmas are analyzed spectroscopically by means of the spectrometer.

In this way, even objects with relatively complex geometry, in particular objects not embodied with a flat form, are analyzed optimally as desired. The type of material of the objects is determined correctly and properly with a high degree of certainty. This is because, by means of the respective analysis lasers, plasma is generated at the respective object at a multiplicity of measurement points, the spectrometer being used to evaluate the emissions, preferably the emission of all these plasmas. If no evaluable plasma is generated by means of one of the two analysis lasers on account of the complex geometry of the object to be analyzed, in the preferred embodiment of the method at least one evaluable plasma is then generated, however, at least by means of the other of the two analysis lasers by means of a high probability. It should be noted at this juncture that the focal points have a certain spatial extent and are generated in particular by corresponding focusing of the laser beams emitted by the analysis lasers.

Alternatively, it is conceivable for the focal point of the second laser, in particular of the ablation laser, to lie outside the field of view of the spectrometer, i.e. outside the field of view realized by the open fiber end. On account of its function, the second laser is then not used/employed as an analysis laser, but rather for “pre-ablation” of the objects.

In a further embodiment or further configuration of the method, the first analysis laser and the second analysis laser are aligned with one another in such a way that the focal point of the first analysis laser and the focal point of the second analysis laser lie one above another spaced apart in particular substantially on a perpendicular to the trajectory of the objects.

The number of measurement points at which a plasma evaluable by means of the spectrometer is generated can thus be increased further. Consequently, the certainty of a correct analysis of the type of material of the objects is increased further. To put it in yet another way: the respective specific material of the objects can be determined very correctly as a result.

In a further, alternative embodiment of the method, the first analysis laser and the second laser, in particular the second analysis laser or the ablation laser, are aligned with one another in such a way that the focal point of the first analysis laser and the focal point of the second laser lie next to one another substantially horizontally in the conveying direction of the objects.

The number of measurement points at which a plasma evaluable by means of the spectrometer is generated, particularly if both lasers are used as analysis lasers in the preferred embodiment, can also be increased further by means of the horizontal arrangement of the focal points. Consequently, by this means, too, the certainty for a correct analysis of the type of material of the objects is increased accordingly. This last holds true in particular even if the second laser is configured and used as an ablation laser. In particular, depending on the specific shape and/or three-dimensional configuration of the objects, the respective aforementioned possibility of aligning the focal points with one another may be very advantageous.

The emissions of the plasmas generated at the objects by the first analysis laser and/or the second analysis laser are captured by means of the open fiber end or are ascertained and/or firstly detected via the open fiber end. The emissions of the plasmas pass in the form of radiation, in particular electromagnetic radiation, from the plasmas to the open fiber end. The emissions or the radiation are or is incoupled into the optical fiber directly at the open fiber end: to put it in yet another way, the emissions or the radiation enter(s) the optical fiber at the open fiber end. By means of the optical fiber, the emissions or the radiation are or is passed on to a sensor or sensors of the spectrometer, wherein the emissions or the radiation can be correspondingly analyzed by means of the spectrometer.

In a further configuration of the method, pulses with a specific pulse repetition rate are emitted by means of the first analysis laser and/or by means of the second laser. The value of said pulse repetition rate in kHz corresponds to a specific value of the speed of the objects upon leaving the feeding means in m/s multiplied by a specific factor, in particular a factor of at least 15. In particular, the first analysis laser and/or the second laser have/has a specific pulse repetition rate. If the second laser is embodied as an ablation laser, the latter has a pulse repetition rate of in particular at least 45 kHz and the first analysis laser then has a pulse repetition rate of in particular at least 5 kHz. If both lasers are embodied as analysis lasers, then the lasers have a pulse repetition rate of in particular at least 20 kHz, in particular of at least 45 KHz.

Given these values of the pulse repetition rate and corresponding, in particular also determined, values of the focal point diameters, an overlap of two successive pulses of the respective analysis laser occurs at the objects. Possible cleaning or pre-ablation at the respective object then also already takes place, in principle, by means of a respective analysis laser, specifically by means of a preceding pulse, wherein in particular the determination of the respective material of the respective object is then made possible correctly with a high degree of certainty by means of the subsequent pulse.

The first analysis laser and/or the second laser, in particular the second analysis laser or the ablation laser, advantageously have/has an alignment device. The alignment of the associated laser and thus the location of the associated focal point are changed as necessary by means of each alignment device. In particular, the spatial arrangement of the two focal points of the first analysis laser and the second laser with respect to one another and in relation to the field of view of the spectrometer can be changed and/or adapted.

In this way, in particular, the flexibility of use of the method is increased. The different arrangements are rapidly settable; under certain circumstances, the alignments are even performed during operation of the system. In this regard, the alignment of the lasers with respect to one another and in relation to the field of view of the spectrometer can be adapted and/or optimized depending on the respective type of objects to be analyzed. It is therefore possible, for example, by means of a further detection means/sensor, e.g. using a camera, to detect the objects during their movement by means of the feeding means or on the feeding means and/or correspondingly to analyze their geometry, size and/or position on the feeding means and accordingly to align the lasers optimally with respect to one another and in relation to the field of view of the spectrometer, in particular automatically by way of the driving of actuators of the alignment devices.

In the preferred embodiment or configuration of the method, a sorting device is provided and/or present, wherein then on the basis of the measurement data generated by means of the spectrometer, in particular depending on an ascertained specific material of the objects, the objects are sorted and/or sorted out into at least two different categories, in particular by means of an air jet.

This sorting simplifies subsequent recycling of the objects, for example, since objects of the same material are better able to be recycled.

In a further configuration of the method, at least one control unit and/or one computer are/is provided and/or present. The feeding means configured in particular as a conveyor belt, in particular the drive of said feeding means, is controlled and/or regulated by means of the control unit and/or the computer, in particular the speed of the conveyor belt. The first analysis laser is controlled and/or regulated by means of the control unit and/or the computer. The second laser, in particular the second analysis laser or the ablation laser, is controlled and/or regulated by means of the control unit and/or the computer. The spectrometer is controlled and/or regulated by means of the control unit and/or the computer or is effectively connected in terms of data technology to the control unit and/or the computer. By means of the control unit and/or the computer, the measurement data generated by means of the spectrometer are evaluated and in particular the material of the objects is determined by this means. In particular, the sorting device is thereupon controlled and/or regulated by means of the control unit and/or the computer.

In particular, a first and/or a second control module are/is provided and/or present for controlling the first analysis laser and/or for controlling the second laser, in particular the second analysis laser or the ablation laser, wherein the first analysis laser and/or the second laser and/or the first and/or second control module are/is embodied and/or configured as an LIBS system or as part of an LIBS system. In particular the optical fiber, in particular also with the open fiber end, and/or the spectrometer are/is configured and/or embodied as part of the LIBS system. In this case, the control modules for the first and/or the second laser can be part of the control unit and/or of the computer functionally and/or in terms of component engineering, in particular can be integrated into the control unit and/or the computer. The control unit and/or the computer are/is also configured in particular as part of the LIBS system or form(s) an essential constituent part here.

In a further configuration of the method, further detection means are provided and/or present, with the aid of which the geometry and/or size and/or position of the objects on the feeding means are/is ascertainable. In particular, a corresponding camera system is provided and/or is effectively connected to the control unit and/or the computer in control engineering terms.

The problem addressed by the invention is now furthermore solved by a system for analyzing objects having the features of patent claim 16.

The essential aspect of the invention now firstly resides in the field of view of the spectrometer being realized by an open fiber end of an optical fiber.

Such an open fiber end is firstly producible particularly simply, in particular producible cost-effectively. Furthermore, the open fiber end, in particular compared with the use of a collimator positioned upstream of the fiber end, is insensitive to inaccuracies in the adjustment of the spectrometer, since the open fiber end has a significantly larger field of view compared with the use of a collimator. Furthermore, by means of the open fiber end, the customary chromatic “aberrations” otherwise occurring at a collimator can be successfully avoided since, by means of the open fiber end, emissions of different wavelengths are captured with the same ratios of the intensities with which they are emitted by the plasma. This is furthermore advantageous if the intensity captured by the open fiber end fluctuates owing to different distances between the plasmas and the open fiber end. This last cannot be avoided on account of the in some instances complex geometries of the objects. However, with the use of the open fiber end (without a collimator being provided) the different intensities can then be captured unambiguously, in particular without corruption of the intensity ratios, and/or then as well can be assigned to the different distances. The open fiber end is in particular positioned so near the trajectory of the objects that the emissions can reach the open fiber end with sufficiently high intensity for an accurate measurement. The emissions of the plasmas generated at the objects by the analysis laser are therefore capturable by means of the open fiber end.

In a further preferred configuration of the system, a preferred distance between the open fiber end and the end of the feeding means, in particular as far as the casting-off edge of the feeding means, has a specific value, in particular of less than 350 mm, in particular between 50 mm and 200 mm. Given these values of the distance, the sufficiently high intensity of the emissions entering the open fiber end is certainly attained.

In a further configuration of the system, the open fiber end has a numerical aperture with a value of 0.14 to 0.28, in particular of 0.18 to 0.24. The full “opening angle” of the open fiber end is in particular 15 to 50 degrees, and in particular lies between 20 and 30 degrees.

The optical fiber is preferably embodied as a so-called step-index fiber, in particular as a multimode fiber. Multiple modes of the radiation captured by the optical fiber can thus propagate or be detected in the optical fiber and/or be communicated to the spectrometer.

In a further embodiment of the system, the optical fiber has a quartz glass core and cladding. In particular, the cladding comprises an outer acrylate cladding and a fluorine-doped intermediate layer.

In one preferred embodiment of the system, the optical fiber has a core diameter with a value of 50 μm to 700 μm, in particular of 400 μm to 600 μm. Given such values of the core diameter, it is ensured that the optical fiber is bendable well enough firstly to position the open fiber end of the optical fiber at the desired position and secondly to effectively connect the optical fiber to further functional elements such as an evaluation unit of the spectrometer or to the spectrometer. Furthermore, this core diameter also affects the intensity of the radiation incoupled into the optical fiber that is high enough for measurement purposes, wherein here there is a substantially quadratic dependence between the incoupled quantity of radiation and the core diameter.

Preferably, a second laser is provided and/or present, wherein the second laser is configured and/or embodied as a second analysis laser or as an ablation laser, wherein a second laser beam with a second focal point is generable by means of the second laser, and wherein the second laser is aligned with the feeding means in such a way that the objects fly through the second laser beam in the region of the second focal point during their respective movement on their respective trajectory.

In this case, the second focal point, if the second laser is configured as a second analysis laser, is also arranged in the field of view of the spectrometer. The first analysis laser and the second analysis laser are then aligned with one another in such a way that the first focal point of the first analysis laser is arranged spaced apart from the second focal point of the second analysis laser, wherein plasmas of the objects are generable by means of the first focal point of the first analysis laser and/or by means of the second focal point of the second analysis laser, and wherein the emissions of said plasmas are analyzable spectroscopically by means of the spectrometer.

In this way, even objects with relatively complex geometry, in particular also of relatively complex three-dimensional geometry, in particular objects not embodied with a flat form, are analyzable as desired. The type of material of the objects is determinable correctly and properly with a high degree of certainty. This is because, by means of the two analysis lasers, a corresponding plasma is generable at the respective object at a multiplicity of measurement points, the spectrometer being able to be used to evaluate the emissions of these plasmas. If no evaluable plasma is generable in particular by means of one of the two analysis lasers on account of a very complex geometry of the object to be analyzed, at least then an evaluable plasma is generable, however, by means of the other of the two analysis lasers by means of a high probability.

Alternatively or furthermore, it is conceivable for the focal point of the second laser, in particular of the ablation laser, to lie outside the field of view of the spectrometer, i.e. outside the field of view realized by the open fiber end. On account of its function, the second laser is then not used/employed as an “analysis laser”, but rather for “pre-ablation” of the objects, i.e. in particular for partial “cleaning” of the objects, before the latter are analyzed with the aid of the first analysis laser.

In one preferred embodiment of the system, the first analysis laser and the second analysis laser are aligned with one another in such a way that the first focal point of the first analysis laser and the second focal point of the second analysis laser are arranged spaced apart one above another on substantially a perpendicular to the trajectory of the objects. The first focal point of the first analysis laser is thus at a different vertical distance with respect to the end, in particular with respect to the casting-off edge of the feeding means or with respect to a plane running horizontally through the end of the feeding means, compared with the second focal point of the second analysis laser. The number of measurement points at which a plasma evaluable by means of the spectrometer is generable can be increased further in this way. Consequently, furthermore, the certainty of a proper and correct analysis of the type of material of the objects is also increased further.

In a further, second preferred embodiment of the system, the first analysis laser and the second laser, in particular the second analysis laser or the ablation laser, are aligned with one another in such a way that the first focal point of the first analysis laser and the second focal point of the second laser are arranged substantially horizontally adjacent to one another in the conveying direction of the objects. The number of measurement points at which a respective plasma evaluable by means of the spectrometer is generable, particularly if the second laser is configured as a second analysis laser, can also be increased further in this way, in particular in a manner dependent on the specific shape, in particular a possible relatively complex three-dimensional configuration of the objects. Consequently, the certainty of a proper and correct analysis of the type of material of the objects is increased further.

The spectrometer therefore now has the optical fiber with the open fiber end for capturing and/or ascertaining and/or detecting the emissions of the plasmas generated at the objects by the first analysis laser and/or by the second analysis laser. Therefore, the field of view of the spectrometer is thus realized in particular exclusively by the open fiber end of the optical fiber.

Such an open fiber end is producible particularly simply. Furthermore, the open fiber end, in particular compared with the use of a collimator upstream of the fiber end, is insensitive to inaccuracies in the adjustment of the spectrometer, since the open fiber end has a significantly larger field of view compared with the use of a collimator upstream of the fiber end. Furthermore, by means of an open fiber end, the chromatic aberrations occurring at a collimator can be successfully avoided since, by means of the open fiber end, emissions of different wavelengths are captured with the same ratios of the intensities. This is furthermore advantageous even if the intensity captured by the open fiber end fluctuates owing to different distances between the plasmas and the open fiber end. This cannot be avoided on account of the in some instances complex geometries of the objects. In this way, however, with the use of the open fiber end the different intensities can then be captured unambiguously, in particular without corruption of the intensity ratios, and/or then as well can be assigned to the different distances. The open fiber end is in particular positioned so near the trajectory of the objects that the emissions reach the open fiber end with sufficiently high intensity for an accurate measurement.

In a further configuration of the system, the first analysis laser and/or the second laser, in particular the second analysis laser, have/has a pulse repetition rate. The value of said pulse repetition rate in kHz corresponds to a specific value of the speed of the objects upon leaving the feeding means in m/s multiplied by a specific factor, in particular a factor of at least 15. If in particular both a first and a second analysis laser are used as lasers, the pulse repetition rates are in particular at least 20 kHz, in particular at least 45 kHz, for at least one or for both of the respective analysis lasers. If an ablation laser is used as second laser, such that a first analysis laser and an ablation laser are used in combination, then the pulse repetition rate for the ablation laser is in particular at least 45 kHz and the pulse repetition rate for the first analysis laser is in particular at least 5 kHz or else correspondingly higher.

In a further embodiment or configuration of the system, the first focal point of the first analysis laser and/or the second focal point of the second laser have/has a focal point diameter of 0.1 mm to 0.2 mm, in particular of 0.15 mm.

Given these values of the pulse repetition rate and these values of the focal point diameters, in particular an overlap of two successive pulses also occurs. Possible cleaning or pre-ablation of the respective objects then additionally also takes place by means of one of the respective analysis lasers, specifically by means of a preceding pulse, wherein the proper and/or correct determination of the material of the object is possible by means of the subsequent pulse.

In one preferred embodiment of the system, the first analysis laser has a first lens for generating the first focal point and the second laser has a second lens for generating the second focal point, wherein the first lens and the second lens each have identical focal length, in particular of 250 mm to 400 mm.

In order to achieve the effect that the first focal point of the first analysis laser is arranged spaced apart from the second focal point of the second laser, in particular the two lasers are also then arranged offset with respect to one another. This last is not absolutely necessary, however; an identical or parallel arrangement of the lasers is also conceivable. With the use e.g. of analysis lasers having an identical focal length, two structurally identical analysis lasers are usable, which also entails cost advantages in the procurement of the analysis lasers.

In an alternative embodiment or configuration of the system, the first lens of the first analysis laser and the second lens of the second laser have mutually different focal lengths, in particular wherein a value of the focal length of the second lens is 5% to 10% less than or greater than a value of the focal length of the first lens. In this way, the two lasers are arrangeable very near to one another and the spacing apart of the focal points of the two lasers with respect to one another is nevertheless achievable.

In a first preferred embodiment or configuration of the system, the first analysis laser, the second laser and the spectrometer are arranged above the trajectory of the objects. The two lasers and the spectrometer are thus arrangeable particularly near the end of the feeding means and thus particularly near the beginning of the trajectory of the objects.

In a further, second preferred embodiment or configuration of the system, the first analysis laser, the second laser and the spectrometer are arranged below the trajectory of the objects. When the lasers are arranged below the trajectory of the objects, however, it is also advantageous in particular that the bearing points of the objects on the feeding means lie in one plane and then, therefore, firstly the distance to the respective lenses, in particular the distance to the respective lens of the first analysis laser and in particular-if present-also to the second analysis laser or to the ablation laser, is also known. Furthermore, a particularly compact arrangement of all the components of the system is made possible.

The first analysis laser and/or the second laser advantageously each have/has an alignment device. The alignment of the associated laser and thus the location of the associated focal point are changeable by means of each alignment device. In particular, the spatial arrangement of the two focal points of the first analysis laser and the second laser with respect to one another and in relation to the field of view of the spectrometer is changeable, settable and/or adaptable, depending on the application.

In this way, in turn the flexibility of use of the system is also increased again. The different arrangements are rapidly settable, in particular under certain circumstances automatically settable even during operation of the system. The alignment of the lasers with respect to one another and in relation to the field of view of the spectrometer depending on the respective type of objects to be analyzed can however be adapted and/or set optimally before operation of the system commences.

In particular, however, the objects on the feeding means are detected by means of a further detection means/sensor, e.g. a camera, in order to analyze their geometry and/or size and/or position, in particular in order to be able to optimally drive the sorting device, in particular the blowing-out nozzle and/or the lasers. In particular, in this case, the feeding means can be configured as a cross-sectionally V-shaped or curved conveyor belt or as a V-shaped or curved chute. In particular, separated feeding of objects into the measurement region or into the region of the focal points is made possible by the feeding means. In particular, the objects have actually already been separated before they are fed by the feeding means. Particularly if the feeding means is embodied as a conveyor belt, in particular as a cross-sectionally V-shaped conveyor belt, this enables the objects to be fed individually or enables the objects to be cast off individually sequentially one after the other starting from the casting-off edge of the conveyor belt, wherein on the basis of the previously ascertained position of the respective object on the conveyor belt and the known speed of the conveyor belt, the first and/or second analysis laser or the ablation laser are/is then also driven accordingly. In the very preferred embodiment or configuration of the method, the lasers are already aligned with the measurement region and/or with the expectable trajectory of the objects before operation of the system, in particular are also permanently activated while the method is being carried out.

In a further embodiment and/or configuration, however, it is also conceivable for the lasers to be aligned with respect to one another and in relation to the field of view of the spectrometer in particular also automatically by way of the driving of actuators during operation, in particular after the size of the object to be analyzed has already been detected and ascertained beforehand.

An angle between the first laser beam and the second laser beam of the first analysis laser and the second laser preferably has a value of less than 30°, in particular less than 20°. In this regard, in particular both laser beams of the analysis lasers are alignable with a small angle in particular with respect to a perpendicular of the spectrometer. In this case, the perpendicular of the spectrometer forms in particular an axis of symmetry of the field of view of the spectrometer and is in particular perpendicular to the open fiber end. This ensures that the emissions of the plasmas of the two analysis lasers can be detected with sufficient intensity and analyzed by the spectrometer.

In a very preferred embodiment or configuration of the system, the feeding means is embodied in particular as a driven conveyor belt. It is also conceivable, in a further embodiment, for the feeding means to be embodied as a chute, in particular as a cross-sectionally V-shaped or curved chute.

The use of a conveyor belt as feeding means is particularly advantageous since the analysis of the objects is further simplified by means of a conveyor belt. This is because the speed of the objects is accurately known on account of the known, settable conveyor belt speed. On account of the known speed of the conveyor belt or of the objects, e.g. the overlap of the impact craters of the pulsed analysis lasers or of the ablation laser is then also known; in particular, the overlap can be set to a value which is advantageous for the analysis of the objects.

In a further embodiment or configuration of the system, the conveyor belt is oriented substantially horizontally. Slipping/sliding of the objects on the conveyor belt is thus avoided. In this context, the term “substantially” means that it is possible to deviate from the horizontal orientation to a small extent, e.g. by a few degrees, in particular ≤10 degrees, particularly if slipping of the objects on the conveyor belt is then nevertheless avoided.

A chute as feeding means can also be advantageous because with the use of a chute there is no need for a separate drive and thus no need for energy for the purpose of moving the objects by means of the feeding means. The movement on the chute then takes place in particular solely on account of the gravitational force of the objects.

In an advantageous further embodiment or configuration of the system, a sorting device is provided and/or present. The objects are sortable on the basis of the measurement data generated by means of the spectrometer, in particular depending on a determined material of the objects, into at least two different categories, in particular by means of an air jet, and in particular are then able to be sorted out in accordance with the respective category. This sorting simplifies e.g. subsequent recycling of the objects since objects of the same material are better able to be recycled.

In one embodiment or configuration of the system, at least one control unit and/or one computer are/is provided and/or present. The control unit and/or the computer are/is effectively connected in terms of control engineering in particular to the feeding means configured as a conveyor belt, in particular to the drive thereof for the control of the speed thereof, for the control and/or regulation thereof. The control unit and/or the computer are/is effectively connected to the first analysis laser for the control and/or regulation thereof. The control unit and/or the computer are/is effectively connected to the second laser for the control and/or regulation thereof. The control unit and/or the computer are/is effectively connected to the spectrometer in terms of control engineering and/or in terms of data technology. By means of the control unit and/or the computer, the measurement data generated by means of the spectrometer are evaluable and in particular the respective material and/or the respective material composition of the objects are/is determinable. In particular, the control unit and/or the computer are/is effectively connected in terms of control engineering to the sorting device for the control and/or regulation thereof. A first and/or a second control module are/is provided and/or present for controlling the first analysis laser and/or for controlling the second laser. In particular, the first analysis laser and/or the second laser are/is embodied and/or configured as an LIBS system or as part of an LIBS system. In particular the optical fiber and/or the open fiber end and/or the spectrometer are/is also configured and/or embodied as part of the LIBS system. The control modules for the lasers can be configured functionally and/or in terms of component engineering as part of the control unit and/or of the computer, and in particular are present there as integrated processual constituent parts. In particular the control unit and/or the computer are/is likewise configured as part of the LIBS system.

In particular, further detection means are provided and/or present, with the aid of which the geometry and/or size and/or position of the fed objects on the feeding means are/is ascertainable; in particular, a corresponding camera system is provided and/or is effectively connected to the control unit and/or the computer in control engineering terms.

In this way, automation of the system is made possible and the effort in respect of manually operating the system is minimizable.

The corresponding system for analyzing and/or sorting objects, in particular the feeding means then present here, has at least one feeding track for feeding the respective objects. In the very preferred embodiment or very preferred configuration, the feeding means for feeding and/or conveying the objects has a plurality of feeding tracks, wherein each feeding track is then assigned at least a respective first analysis laser and a respective field of view of a spectrometer; in particular, therefore, each feeding track is assigned a respective optical fiber with an open fiber end. In a very preferred configuration, each feeding track is also assigned a respective separate spectrometer; in particular, therefore, each optical fiber is connected to an associated separate spectrometer. The respective feeding tracks can be configured as physically and/or mechanically separate feeding tracks in particular on the feeding means or a plurality of single-track feeding means can also be provided. In one preferred form of embodiment or form of configuration, the feeding means is configured as a conveyor belt having a width of appropriate magnitude, wherein a plurality of “virtually” separate feeding tracks are then formed on this conveyor belt, in particular by corresponding separation devices which are present in the prior stage and which then feed the objects to the feeding means in a manner distributed over the respective width of the conveyor belt, in particular feed the objects to the conveyor belt in a manner distributed over the width thereof; attention should be drawn to this. For the case where a plurality of feeding tracks are present, the distance between the respective first analysis lasers adjacent to one another or the distance between the respective open fiber ends arranged adjacent to one another is in particular 20 to 200 millimeters, preferably 50 to 100 millimeters. To put it in yet another way, the distance between adjacent feeding tracks is in particular to 200 millimeters, preferably 50 to 100 millimeters. Particularly for the case where a plurality of feeding tracks are formed, the sorting device then has a plurality of blowing-out nozzles; in particular, the sorting device then has a corresponding nozzle strip comprising these aforementioned blowing-out nozzles; in this case, each feeding track is then assigned at least one blowing-out nozzle. For the case where provision is made of a second laser, in particular a second analysis laser or an ablation laser as second laser, then each feeding track is also assigned a respective second laser. The explanations given above, in particular regarding the distances between the second lasers then arranged adjacent to one another, are analogously applicable, mutatis mutandis; attention should be drawn to this, too.

In a further preferred embodiment or configuration, provision can also be made for the objects which are not identifiable or are only inadequately identifiable then to be feedable again to the feeding means with the aid of a return system then present. The return system then used or present then has in particular a further blowing-out nozzle or a further second nozzle strip and/or further conveyor belts in order that the aforementioned objects which are not identified or are only inadequately identified can be fed or are correspondingly fed in particular to the feeding means then once again for a new further analysis.

There are, then, a multiplicity of possibilities for advantageously configuring and developing the method according to the invention for analyzing objects and respectively the system according to the invention for analyzing objects. In this respect, reference should firstly be made to the patent claims subordinate to patent claim 1 and respectively to those subordinate to patent claim 16. A preferred configuration of the method according to the invention for analyzing objects and of the system according to the invention for analyzing objects will now be explained or described in greater detail below with reference to the drawing and on the basis of the associated description. In the drawing:

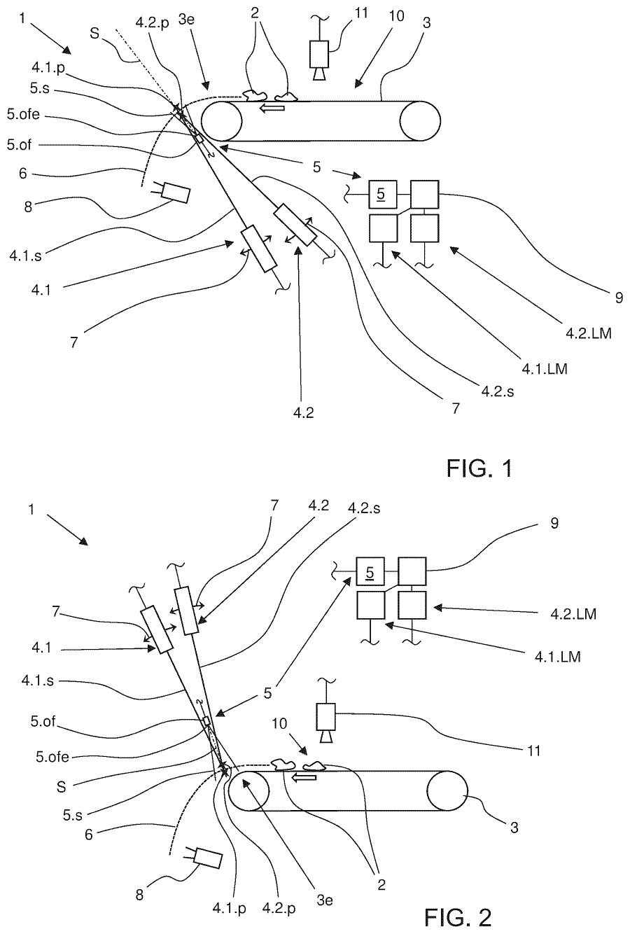

FIG. 1 shows a highly simplified schematic illustration of a first exemplary embodiment of the system for analyzing objects in a side view,

FIG. 2 shows a highly simplified schematic illustration of a second exemplary embodiment of the system for analyzing objects in a side view,

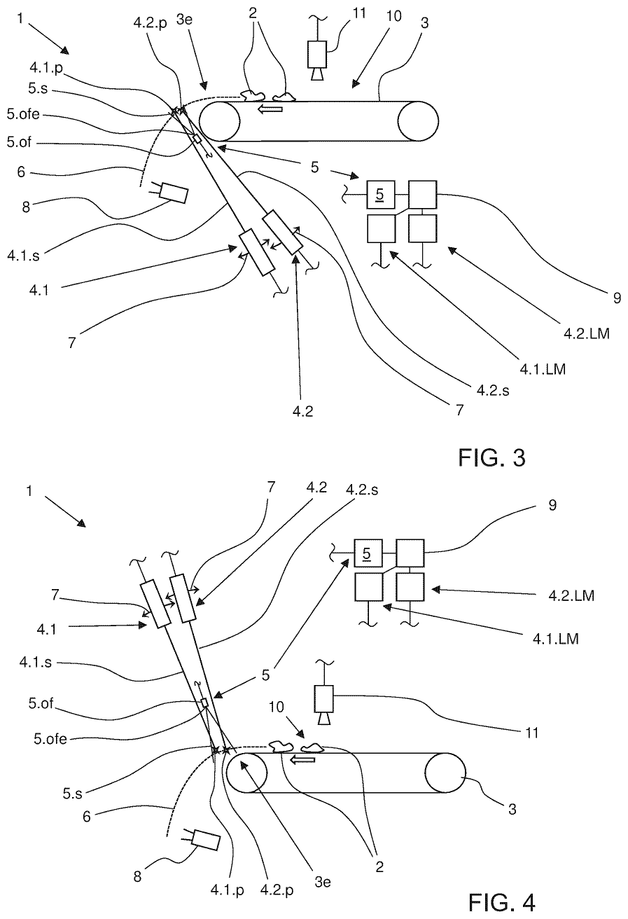

FIG. 3 shows a highly simplified schematic illustration of a third exemplary embodiment of the system for analyzing objects in a side view,

FIG. 4 shows a highly simplified schematic illustration of a fourth exemplary embodiment of the system for analyzing objects in a side view,

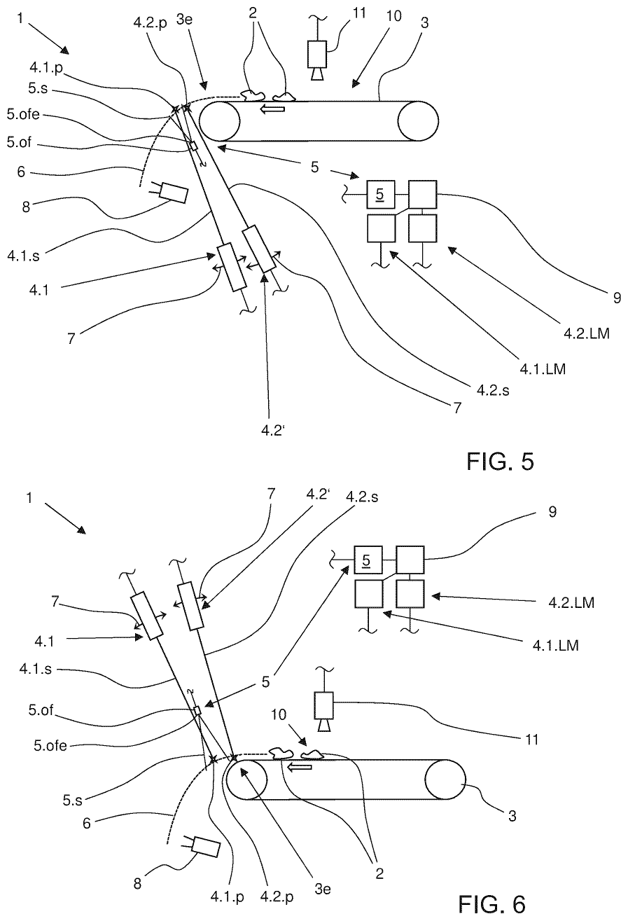

FIG. 5 shows a highly simplified schematic illustration of a fifth exemplary embodiment of the system for analyzing objects in a side view,

FIG. 6 shows a highly simplified schematic illustration of a sixth exemplary embodiment of the system for analyzing objects in a side view,

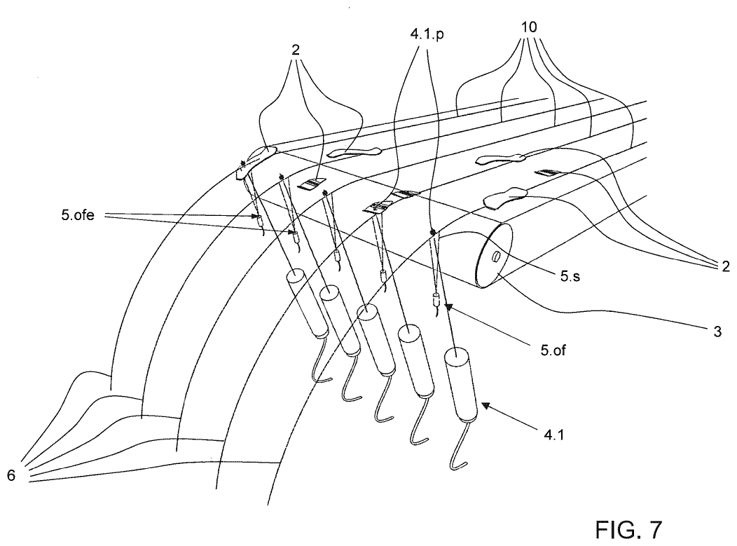

FIG. 7 shows a highly simplified schematic illustration of a seventh exemplary embodiment of the system for analyzing objects in a slightly perspective illustration, wherein the system illustrated here in FIG. 7 has a plurality of feeding tracks for feeding/conveying the objects, and

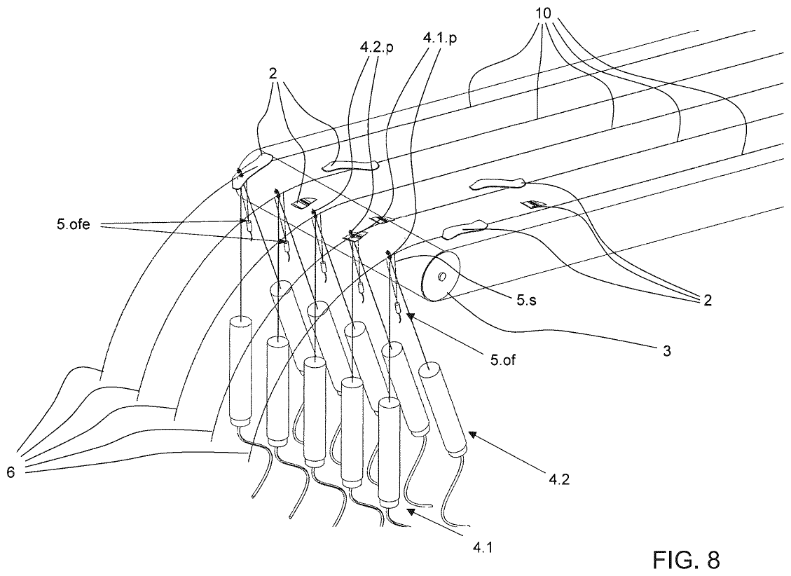

FIG. 8 shows a highly simplified schematic illustration of an eighth exemplary embodiment of the system for analyzing objects in a slightly perspective illustration, almost corresponding to FIG. 1, wherein the system illustrated here in FIG. 8 has a plurality of feeding tracks for feeding/conveying the objects.

FIG. 1 to FIG. 8 show eight respective exemplary embodiments of a system 1 according to the invention for analyzing objects 2 in a highly simplified schematic illustration.

FIGS. 1 to 6 show respective embodiments or configurations of the system 1 in a side view substantially illustrating only one feeding track 10 formed on the feeding means 3 for the purpose of feeding the separated objects 2.

FIGS. 7 and 8 essentially in part also show essential components of the system 1 in a perspective illustration, but here a plurality of feeding tracks 10 are discernible or here a plurality of feeding tracks 10 are formed on the feeding means 3. At this juncture, it should be pointed out that not all of the components illustrated in FIGS. 1 to 6, for example, are illustrated in particular in FIGS. 7 and 8. The corresponding explanations, in particular concerning FIGS. 1 to 4, are therefore analogously applicable, mutatis mutandis, essentially also to the exemplary embodiments illustrated in FIGS. 7 and 8, where here in comparison with FIGS. 1 to 6 a plurality of feeding tracks 10 are illustrated, rather than just one; attention should be drawn to this. In all of the figures, essentially the same reference signs are used for identical or similar components.

The method according to the invention for analyzing and/or sorting objects 2 as described below is essentially implementable with all these eight exemplary embodiments illustrated in FIGS. 1 to 8.

The system 1 illustrated here in FIG. 1 to FIG. 8 or respectively the method realizable by the system 1 is suitable for various kinds of application. By means of this system 1 or respectively method, specific different objects 2 can be analyzed and/or sorted, in particular sorted out, such as e.g. metal parts, metal scrap, in particular aluminum scrap, lumps of ore, batteries, packagings, waste or the like. The system 1 or respectively the method is therefore suitable in particular for the separation and/or sorting of pieces of metal, the recycling industry and/or is used in the field of mining and when extracting ores and/or minerals. A multiplicity of applications are conceivable and possible. The very preferred application is in particular the sorting of metal parts and/or aluminum scrap. Particularly when sorting out or sorting aluminum scrap, sorting/selection into the different classes 1XXX-8XXX according to the standard DIN EN 573-3 or DIN EN 573-4 and also within these classes, e.g. between 6005 and 6061, is then possible. The aforementioned “classes” may in particular then form the different “categories” for sorting the objects 2, for example.

Firstly, at least one feeding means 3, a—first—analysis laser 4.1 and at least one spectrometer 5 are provided and/or present. The objects 2 are fed and/or moved, in particular conveyed, with the aid of the feeding means 3, in particular to a measurement region/analysis region, wherein starting from an end 3e of the feeding means 3 the objects 2, for the analysis thereof, move on a trajectory 6, in particular are cast off from the feeding means 3, this last particularly if the feeding means is configured as a driven or motor-drivable conveyor belt.

A—first-laser beam 4.1.s with a—first—focal point 4.1.p is generated by means of the—first—analysis laser 4.1. The analysis laser 4.1 is aligned with the feeding means 3 in such a way that the objects 2 fly through the laser beam 4.1.s in the region of the focal point 4.1.p during their respective movement on their respective trajectory 6. A field of view 5.s of the spectrometer 5 has been and/or is aligned with a region of the trajectory 6 of the objects 2. The focal point 4.1.p of the analysis laser 4.1 therefore lies in the field of view 5.s of the spectrometer 5.

Plasmas of the objects 2 are generated by means of the focal point 4.1.p of the analysis laser 4.1. Emissions of these plasmas are analyzed spectroscopically by means of the spectrometer 5.

The disadvantages mentioned in the introduction are now avoided firstly by virtue of the field of view 5.s of the spectrometer 5 being realized by an open fiber end 5.ofe of an optical fiber 5.of. The emissions of the plasmas generated at the objects 2 by the analysis laser 4.1 are captured by means of the open fiber end 5.ofe.

The open fiber end 5.ofe firstly saves costs since the open fiber end 5.ofe is producible simply and cost-effectively. The collimator used hitherto in the prior art is not necessary. In particular, the open fiber end 5.ofe is insensitive to inaccuracies in the adjustment of the spectrometer 5; in particular, the open fiber end 5.ofe has a significantly larger field of view compared with the use of a collimator (as hitherto in the prior art). By virtue of the field of view 5.s being realized exclusively by the open fiber end 5.ofe of the optical fiber 5.of, therefore, the advantages mentioned in the introduction are afforded and disadvantages are avoided.

The further explanations may now be given below, these being applicable in principle firstly to all of FIGS. 1 to 8, although with the difference that the laser 4.2 illustrated in FIGS. 1 to 4 and FIG. 8 is configured and/or embodied here as an analysis laser 4.2, and the laser 4.2′ illustrated in FIGS. 5 and 6 is embodied as an ablation laser 4.2′. By contrast, FIG. 7 shows only one laser, namely a first analysis laser 4.1, whereas two lasers, namely a first analysis laser 4.1 and a second laser, either a second analysis laser 4.2 or an ablation laser 4.2′, are provided in all the rest of the figures. Taking these aspects into consideration, the following may now be explained in particular with respect to FIGS. 1 to 8:

A second laser beam 4.2.s with a second focal point 4.2.p is generated with the aid of a second laser 4.2 or 4.2′, in particular a second analysis laser 4.2 or an ablation laser 4.2′. The second analysis laser 4.2, too, has been and/or is aligned with the feeding means 3 in such a way that the objects 2 fly through the second laser beam 4.2.s in the region of the second focal point 4.2.p during their respective movement on their respective trajectory 6. The second focal point 4.2.p of the second laser 4.2 or 4.2′ lies in the field of view 5.s of the spectrometer 5 in the case of the exemplary embodiments in accordance with FIGS. 1 to 4 and FIG. 8 or outside the field of view 5.s pof the spectrometer 5 in the case of the exemplary embodiments in accordance with FIGS. 5 and 6 (FIG. 7 shows one—first—analysis laser 4.1 per feeding track 10).

The first analysis laser 4.1 and the second laser 4.2 or 4.2′ have been and/or are aligned with one another in such a way that the first focal point 4.1.p of the first analysis laser 4.1 is spaced apart from the second focal point 4.2.p of the second laser 4.2 or 4.2′. Plasmas of the objects 2 are generated by means of the first focal point 4.1.p of the first analysis laser 4.1 and/or by means of the second focal point 4.2.p of the second analysis laser 4.2. Emissions of these plasmas are then analyzed spectroscopically by means of the spectrometer 5.

It is conceivable for the spectrometer 5 and the first analysis laser 4.1 and/or the second laser 4.2 or 4.2′ to be arranged in a common housing; in particular, the first analysis laser 4.1 and the second laser 4.2 or 4.2′ and also the spectrometer 5 are embodied as an LIBS system or are corresponding constituent parts of an LIBS system.

The first analysis laser 4.1 and the second analysis laser 4.2 are aligned with one another in particular in such a way that the first focal point 4.1.p of the first analysis laser 4.1 and the second focal point 4.2.p of the second analysis laser 4.2 lie one above another spaced apart on substantially a perpendicular S to the trajectory 6 of the objects 2. In this case, the expression “substantially” means in particular that the corresponding virtual connecting line between the two focal points 4.1.p and 4.2.p may also have an inclination of up to +/−15 degrees, in particular of up to +/−10 degrees, relative to the perpendicular S. In this case, the “perpendicular S” is a virtual line which then is perpendicular to a tangent of a specific and/or selected point of the known and/or predicted trajectory 6 of the objects 2 or is correspondingly oriented perpendicularly to this tangent. This situation is illustrated in FIG. 1 and FIG. 2 and also FIG. 8, but the perpendicular S is illustrated only in FIGS. 1 and 2.

Alternatively, the first analysis laser 4.1 and the second laser 4.2 or 4.2′ can be aligned with one another in such a way that the first focal point 4.1.p of the first analysis laser 4.1 and the second focal point 4.2.p of the second laser 4.2 or 4.2′ are substantially horizontally adjacent to one another-in the conveying direction of the objects 2. In this case, the expression “substantially” means in particular that the corresponding virtual connecting line between the two focal points 4.1.p and 4.2.p can also have an inclination of up to +/−10 degrees, in particular up to +/−5 degrees, relative to the horizontal. In this case, the term “are substantially horizontally adjacent to one another in the conveying direction of the objects 2” not only encompasses the first and second focal points which are arranged horizontally adjacent to one another and directly also lie at the level of the casting-off edge 3e of the feeding means 3, but also encompasses the first and second focal points which are adjacent to one another on a horizontal, the horizontal then being at a specific height distance from the casting-off edge 3e or running parallel and spaced apart with respect to the area of a conveyor belt in the conveying direction. This situation is illustrated in FIG. 3, FIG. 4, FIG. 5 and FIG. 6 and.

In the preferred configuration, the first focal point 4.1.p of the first analysis laser 4.1 and the second focal point 4.2.p of the second laser 4.2 or 4.2′ lie partly horizontally and partly vertically spaced apart from one another, i.e. in particular are spaced apart from one another with a vertical and horizontal respective distance component. In particular the first focal point then lies “obliquely” below or “obliquely” above the second focal point (or vice versa), but in particular one above another on substantially a perpendicular S to the trajectory 6 of the objects 2.

The spectrometer 5 now has an optical fiber 5.of with an open fiber end 5.ofe, or an optical fiber 5.of having an open fiber end 5.ofe is now provided and/or present. The emissions of the plasmas generated at the objects 2 by the first analysis laser 4.1 and/or the second analysis laser 4.2 are captured or detected by means of the open fiber end 5.ofe. In this case, the spectrometer 5 is illustrated schematically “in the shape of a box” at least in part in the figures, arrows then also indicating that the spectrometer 5 is correspondingly connected to the optical fiber 5.of.

The field of view 5.s of the spectrometer 5 is thus realized by the open fiber end 5.ofe of the optical fiber 5.of. A distance between the open fiber end 5.ofe and the end 3e of the feeding means 3, in particular the casting-off edge of the feeding means 3, has a specific value, in particular of less than 350 mm, in particular between 50 mm and 200 mm. In this case, this distance is measured in particular between the open fiber end 5.ofe and the “casting-off point” of the object 2 from the feeding means 3 or the beginning of the trajectory 6 of the object 2.

The open fiber end 5.ofe has a numerical aperture with a value of 0.14 to 0.28, in particular of 0.18 to 0.24. A full opening angle of the open fiber end 5.ofe is in particular in the range of between 15 and 50 degrees, in particular in the range of 20 to 30 degrees.

The optical fiber 5.of is embodied as a “step-index fiber”, in particular as a multimode fiber.

The optical fiber 5.of has in particular a quartz glass core and a cladding. In particular, the cladding comprises an outer acrylate cladding and a fluorine-doped intermediate layer.

The optical fiber 5.of has a core diameter with a value of 50 μm to 700 μm, in particular of 400 μm to 600 μm.

Pulses with a specific pulse repetition rate are emitted by means of the first analysis laser 4.1 and/or by means of the second laser 4.2 or 4.2′. The value of said pulse repetition rate in kHz corresponds in particular to a specific value of the speed of the objects 2 upon leaving the feeding means 3 in m/s multiplied by a specific factor, in particular a factor of at least 15. For the case where only a first analysis laser 4.1 is used in the respective exemplary embodiments (here FIG. 7, in particular), the first analysis laser 4.1 has in particular a pulse repetition rate of at least kHz, in particular of at least 45 kHz. For the case where a first analysis laser 4.1 is used in combination with a second analysis laser 4.2, these two lasers likewise have in particular the aforementioned pulse repetition rates. Finally, if a first analysis laser 4.1 is used in combination with an ablation laser 4.2′(cf. FIGS. 5 and 6, in particular), the ablation laser 4.2′ has in particular a pulse repetition rate of in particular at least 45 kHz, wherein the first analysis laser 4.1 then can have or has at least a pulse repetition rate of 5 kHz or else more.

In particular, the first analysis laser 4.1 and the second analysis laser 4.2 are embodied structurally identical. In particular, these can also be installed jointly with other components of the LIBS system in a common housing.

In the case of the exemplary embodiment shown in FIGS. 5 and 6, the second laser illustrated here is embodied in particular as an ablation laser 4.2′ and is also configured in particular as a constituent part of the LIBS system. This second laser 4.2 or 4.2′ in FIGS. 5 and 6 can therefore also be installed together with the first analysis laser 4.1 in a common housing.

The first analysis laser 4.1 and/or the second laser 4.2 or 4.2′ have/has in particular an alignment device 7. The alignment of the associated analysis laser 4.1, 4.2 or of the ablation laser 4.2′ and thus the location of the associated focal point 4.1.p, 4.2.p are thus changed, set and/or adapted as necessary by means of each alignment device 7. In particular, the spatial arrangement of the two focal points 4.1.p, 4.2.p of the first analysis laser 4.1 and of the second laser 4.2 or 4.2′with respect to one another and in relation to the field of view 5.s of the spectrometer 5 is changed.

The alignment devices 7 are symbolized here in FIGS. 1 to 6 with the aid of arrows adjoining the analysis lasers 4.1, 4.2 or the second laser 4.2 or 4.2′. It is conceivable for only one of the two analysis lasers 4.1 or 4.2 or the ablation laser 4.2′ to have an alignment device 7. Likewise, each laser can have a respective alignment device 7. It is furthermore conceivable for only one alignment device 7 to be provided and/or present, but this one alignment device 7 then serves to move and align both analysis lasers 4.1 and 4.2 or the first analysis laser 4.1 and the ablation laser 4.2′.

In one preferred embodiment or configuration of the system 1 or of the method, the first analysis laser 4.1 and the second laser 4.2 or 4.2′ are aligned before the analysis and/or sorting process, in particular taking into consideration the structure and/or geometry and/or the expected size of the objects 2 to be analyzed and/or to be sorted. An alignment of the first and/or second analysis laser 4.1 and 4.2 or of the ablation laser 4.2′ while the method is being carried out is then no longer absolutely necessary after a single occurrence of optimized alignment.

It is conceivable, however, for the first analysis laser and the second laser 4.2 or 33 4.2′ to be aligned in particular automatically during the method, too, in particular if by way of further detection means 11 provided, in particular a camera system, a different, in particular unexpected, more complex structure, geometry and/or size of the objects 2 to be analyzed and/or to be sorted on the feeding means 3 are/is ascertained, outside the expected tolerance range of the objects 2 to be analyzed and/or to be sorted.

Furthermore, the spectrometer 5 itself could also analogously have an alignment device. Different types of alignment devices 7 e.g. with corresponding actuators are therefore conceivable, such actuators then also being drivable in an automated manner.

In particular, the analysis lasers 4.1 and/or 4.2 or the ablation laser 4.2′ are is rotatable about an axis, in particular substantially perpendicularly to the direction of movement of the objects 2, or about an axis running parallel to the axis of a deflection roller (not designated more specifically) of the conveyor belt, and/or are/is displaceable in a plane running through the trajectory 6 of the objects 2.

In the preferred embodiment or configuration, the first analysis laser 4.1 and the second laser 4.2 or 4.2′, in particular also the spectrometer 5, are aligned manually, and are then correspondingly fixed and aligned in particular for example in correspondingly associated slotted receptacles of a framework, in particular with the aid of screw connections. This is done in particular before operation of the system 1 commences or before the method is carried out.

A sorting device 8 is provided and/or present. The objects 2 are sorted on the basis of the measurement data generated by means of the spectrometer 5, in particular depending on a determined material of the objects 2, into at least two different categories, in particular by means of an air jet. The sorting device 8 therefore has in particular at least one correspondingly drivable blowing-out nozzle.

For each category in this case a container is provided, in particular, in which the objects 2 are collected and by means of which the objects 2 can then be fed for further processing, for example recycling of the objects 2. Such containers or vessels or else further conveying means conceivable therefor for taking objects away are not illustrated any further here in FIGS. 1 to 8.

At least one control unit 9 and/or one computer 9 are/is provided and/or present. In particular the feeding means 3 configured as a conveyor belt, in particular the speed thereof, is controlled and/or regulated by means of the control unit 9 and/or the computer 9. The first analysis laser 4.1 is controlled and/or regulated by means of the control unit 9 and/or the computer 9. The second laser 4.2 or 4.2′ is controlled and/or regulated by means of the control unit 9 and/or the computer 9. The spectrometer 5 is controlled and/or regulated by means of the control unit 9 and/or the computer 9 or is effectively connected to the control unit 9 and/or the computer 9 in terms of data technology. By means of the control unit 9 and/or the computer 9, the measurement data generated by means of the spectrometer 5 are evaluated, wherein in particular the respective specific material, e.g. a specific metal or a plastic, of the respective objects 2 is determined.

In particular, the sorting device 8 is also controlled and/or regulated by means of the control unit 9 and/or the computer 9; in particular, a blowing-out nozzle of the sorting device 8 is driven accordingly. In particular, therefore, the sorting device 8 has a blowing-out nozzle, and in particular is configured as a nozzle strip with a plurality of blowing-out nozzles.

A first and/or second control module 4.1.LM and 4.2.LM are/is provided and/or present for controlling the first analysis laser 4.1 and for controlling the second laser 4.2 or 4.2′. In this case, the first analysis laser 4.1 and the second laser 4.2 or 4.2′ are embodied and/or configured in particular as an LIBS system or as part of an LIBS system. In particular the optical fiber (5.of) and/or the open fiber end (5.ofe) and also the spectrometer (5) are also configured and/or embodied as part of the LIBS system or an LIBS system is formed by the aforementioned components and, therefore, the objects 2 are also analyzed by an LIBS method and sorted, in particular partly sorted out, on the basis of the measurement data ascertained.

The control modules 4.1.LM and 4.2.LM for the respective lasers are embodied functionally and/or in terms of component engineering in particular also as part of the control unit and/or of the computer 9; in particular, the control unit and/or the computer 9 are/is also configured as part of or a further component of the LIBS system.

In the preferred embodiment or configuration, further detection means 11 are provided and/or present, with the aid of which the geometry and/or size and/or position of the fed objects 2 on the feeding means 3 are/is ascertainable; in particular, a corresponding camera system is provided or present and/or is effectively connected to the control unit and/or the computer 9 in terms of control engineering.

In particular, all the components of the system 1 are controlled and/or regulated by means of the control unit 9 and/or the computer 9, wherein an optimization of the system 1 is able to be carried out in a simple manner by taking into consideration the dependencies of the various components among one another.

In FIGS. 1 to 8, in each case a connection effective in terms of control engineering and/or a data connection between the spectrometer 5, the two analysis lasers 4.1 and 4.2 or the ablation laser 4.2′ and the control unit 9 and/or the computer 9 are/is discernible or schematically indicated by means of a respective line, which however is only partly illustrated or is illustrated in a partly interrupted manner. It is theoretically also conceivable, however, for the respective components to be controlled and/or regulated separately, e.g. by means of separate further control units and/or computers.

In FIGS. 1 to 8—at least in part—the spectrometer 5 and the two analysis lasers 4.1 and 4.2 or the ablation laser 4.2′ are illustrated in each case by means of a plurality of schematic elements, wherein a connection between these respective elements e.g. for transmitting data and/or energy is symbolized in particular by means of partly interrupted lines then illustrated here in each case. With regard to the illustration in FIGS. 1 to 4 and FIG. 8, the following should also be pointed out:

In the preferred embodiment, the first and second analysis lasers 4.1 and 4.2 and/or the control modules 4.1.LM and 4.2.LM present for the first and second analysis lasers 4.1 and 4.2 are configured as part of an LIBS system. To put it in yet another way, the first and second analysis lasers 4.1 and 4.2 are configured in particular as a respective LIBS analysis laser, wherein the LIBS system also has in particular the optical fiber 5.of and the control modules 4.1.LM and 4.2.LM. The LIBS system includes in particular the spectrometer 5 and in particular also the control unit and/or the computer 9. Parts of these aforementioned components, in particular the first and second analysis lasers 4.1 and 4.2 and also a part of the optical fiber 5.of with the open fiber end 5.ofe, can in this case be installed and/or arranged in particular in a common housing; attention should be drawn to this, too.

The explanations given above are essentially analogously applicable to the exemplary embodiments in FIGS. 5 and 6, wherein here the second laser is configured and embodied as an ablation laser 4.2′. The lasers illustrated here in FIGS. 5 and 6, i.e. here the first analysis laser 4.1 and the second laser 4.2′, i.e. the ablation laser, are also configured in particular as part of the LIBS system.

FIG. 7 shows a respective analysis laser 4.1 and a respective open fiber end 5.ofe, in particular for a respective feeding track 10, i.e. a respective analysis laser 4.1 and a respective open fiber end 5.ofe per feeding track 10. Not all of the components are illustrated here in FIG. 7 (and FIG. 8), but the explanations given above are essentially analogously applicable, wherein in particular here as well in FIG. 7 the plurality of the feeding tracks 10 on the conveying means 3 are discernible and the first analysis laser 4.1 used here and the respective open fiber ends 5.ofe are configured and/or configured as part of an LIBS system, as already described above.

Hereinafter now once again the system 1 for analyzing objects 2 in accordance with the eight different exemplary embodiments of the system 1 from FIG. 1 to FIG. 8 will be discussed once again in more specific detail or this system will be described once again in more specific detail:

The system 1 for analyzing objects 2 serves in particular for carrying out the method described above.

The system 1 for analyzing objects 2 comprises the feeding means 3, the-first analysis laser 4.1 and the spectrometer 5. The feeding means 3 is in particular also able to be referred to as “conveying means”. The objects 2 are feedable with the aid of the feeding means 3 in particular to a corresponding measurement region or analysis region after the end of the feeding means or are movable to there, in particular conveyable with the aid of a feeding means 3 configured as a conveyor belt.

In this case, the feeding means 3 is configured in particular such that the objects 2 can be separated and/or the objects 2 in each case in a separated manner one after another, starting from the end 3e of the feeding means 3, move firstly into a measurement region or analysis region on a/their respective trajectory 6.

In particular, the feeding means 3 can have a V-shaped cross-section for realizing the separation of the objects 2 and/or for realizing separated transport of the objects 2. The feeding means 3 is therefore embodied in particular as a cross-sectionally V-shaped or curved conveyor belt. A cross-sectionally V-shaped or curved chute is also conceivable as an alternative.

Starting from the end 3e, in particular starting from a casting-off edge, of the feeding means 3, the objects 2 are moved on a trajectory 6 for the purpose of their analysis; in particular, the objects 2 are cast off from the feeding means 3 and then move on and/or along a trajectory 6.

A—first—laser beam with a—first—focal point 4.1.p is generable by means of a—first—analysis laser 4.1. The analysis laser 4.1 is aligned with the feeding means 3 in such a way that the objects 2 fly through the laser beam 4.1.s in the region of the focal point 4.1.p during their respective movement on their respective trajectory 6.

The spectrometer 5 has the field of view 5.s. The field of view 5.s of the spectrometer 5 is aligned with a region of the trajectory 6 of the objects 2.

The field of view 5.s of the spectrometer 5 is now realized by the open fiber end 5.ofe of the optical fiber 5.of.

The first focal point 4.1.p of the first analysis laser 4.1 is arranged in the field of view of the spectrometer 5; this is applicable here to all the exemplary embodiments in FIGS. 1 to 8.

A second laser 4.2 is now provided and/or present in FIGS. 1 to 6 and FIG. 8. The second laser 4.2 or 4.2′ is now embodied as a second analysis laser 4.2 in the exemplary embodiments in FIGS. 1 to 4 and FIG. 8 and as an ablation laser 4.2′ in the exemplary embodiments in FIGS. 5 and 6. A second laser beam 4.2.s with a second focal point 4.2.p is generable by means of the second laser 4.2 or 4.2′. The second laser 4.2 or 4.2′, too, is aligned with the feeding means 3 in such a way that the objects 2 fly through the second laser beam 4.2.s in the region of the second focal point 4.2.p during their respective movement on their respective trajectory 6.

The second focal point 4.2.p of the second laser 4.2, in particular of the second analysis laser 4.2 in the case of FIGS. 1 to 4 and FIG. 8, is arranged in the field of view 5.s of the spectrometer 5.

In the case of the exemplary embodiments in FIGS. 5 and 6, a first analysis laser 4.1 and a second laser, embodied as an ablation laser 4.2′, are provided here. The above explanations are essentially analogously applicable, with the exception that the second focal point 4.2.s of the second laser 4.2 in FIGS. 5 and 6 lies outside the field of view 5.s.

In the case of the exemplary embodiment illustrated in FIG. 7, here a respective—first—analysis laser 4.1 is provided, and is assigned here to the respective feeding tracks 10. FIG. 7 therefore shows a plurality of analysis lasers 4.1 arranged adjacent to one another and a plurality of optical fibers 5.of or optical fiber ends 5.ofe arranged adjacent to one another, which are respectively assigned to the respective feeding tracks 10. FIG. 8 shows a first analysis laser 4.1 and a second analysis laser 4.2 for each feeding track 10. Therefore, a plurality of lasers 4.1/4.2 or optical fibers 5.of and feeding tracks 10 are also present or configured here, each feeding track 10 being assigned at least a first and a second analysis laser 4.1 and 4.2 and also an optical fiber end 5.ofe. It should once again be pointed out at this juncture that in particular the exemplary embodiments in FIGS. 7 and 8 do not show all of the corresponding components which are illustrated in FIGS. 1 to 4, for example. Nevertheless, these corresponding components are then correspondingly provided or present analogously in the case of FIGS. 7 and 8 as well; attention should once again be drawn to this.

In the case of FIGS. 1 to 4 and FIG. 8, the first analysis laser 4.1 and the second analysis laser 4.2 are aligned with one another in such a way that the first focal point 4.1.p of the first analysis laser 4.1 is arranged spaced apart from the second focal point 4.2.p of the second analysis laser 4.2. Plasmas of the objects 2 are generable by means of the first focal point 4.1.p of the first analysis laser 4.1 and/or by means of the second focal point 4.2.p of the second analysis laser 4.2. The emissions of these plasmas are analyzable spectroscopically by means of the spectrometer 5. The first analysis laser 4.1 and the second analysis laser 4.2 are aligned with one another in particular in such a way that the first focal point 4.1.p of the first analysis laser 4.1 and the second focal point 4.2.p of the second analysis laser 4.2 are arranged one above another spaced apart in particular on substantially a perpendicular S to the trajectory 6 of the objects 2. This situation is illustrated in FIG. 1 and FIG. 2 and also FIG. 8, although the perpendicular S is illustrated only in FIGS. 1 and 2.

The first analysis laser 4.1 and the second analysis laser 4.2 are alternatively aligned with one another in such a way that the first focal point 4.1.p of the first analysis laser 4.1 and the second focal point 4.2.p of the second analysis laser 4.2 are arranged substantially horizontally adjacent to one another in the conveying direction of the objects 2. The situation is illustrated in FIGS. 3 and FIG. 4. In FIGS. 5 and 6, the focal points of the lasers 4.1.p and 4.2.p therein are also arranged substantially horizontally adjacent to one another in the conveying direction of the objects 2, but here the second laser is embodied as an ablation laser 4.2′, wherein the corresponding focal point 4.2.p lies outside the field of view 5.s of the optical fiber 5.ofe; attention should once again be drawn to this, too, at this juncture.

In the very preferred configuration, the first focal point 4.1.p of the first analysis laser 4.1 and the second focal point 4.2.p of the second analysis laser 4.2 are positioned in particular partly vertically, partly horizontally with respect to one another, i.e. in particular are correspondingly spaced apart with corresponding horizontal and/or vertical spacings with respect to one another, or, put simply, the focal points then lie obliquely offset with respect to one another, in particular lie on substantially a perpendicular S to the trajectory 6 of the objects 2. Attention should be drawn to this, too.

The above explanations concerning FIGS. 1 to 4 are essentially analogously applicable to FIGS. 5 to 6 with the proviso that here the second laser is not actually embodied as an analysis laser, but rather as an ablation laser 4.2′, in which case here the two focal points, i.e. the first focal point 4.1.s of the first analysis laser 4.1 and the second focal point 4.2.s of the second laser, namely of the ablation laser 4.2′, are then substantially horizontally spaced apart from one another—as viewed in the conveying direction of the objects 2—as illustrated in FIGS. 5 and 6, and in which case the second focal point 4.2.p lies outside the field of view 5.s, however. The plasmas generated by the ablation laser 4.2′ are therefore not analyzed by the spectrometer 5, since only the plasmas generated by the first analysis laser 4.1 or the emissions resulting therefrom reach the sensors of the spectrometer 5 via the open fiber end 5.ofe.

The spectrometer 5 now has the optical fiber 5.of with the open fiber end 5.ofe, or an optical fiber 5.of is now provided and/or present, which has in particular exclusively an open fiber end 5.ofe for capturing the emissions of the plasmas generated at the objects 2 by the first analysis laser 4.1 and/or the second analysis laser 4.2.

The first analysis laser 4.1 and/or the second laser 4.2 or 4.2′ have/has a pulse repetition rate. The value of this pulse repetition rate in kHz corresponds in particular to a specific value of the speed of the objects 2 upon leaving the feeding means 3 in m/s multiplied by a specific factor, in particular a factor of at least 15.

The first focal point 4.1.p of the first analysis laser 4.1 and/or the second focal point 4.2.p of the second laser 4.2 or 4.2′ have/has a focal point diameter of 0.1 mm to 0.2 mm, in particular of 0.15 mm. In this case, the respective focal point diameter is measured perpendicular to the respective laser beam 4.1.s or 4.2.s.

The first analysis laser 4.1 has a first lens for generating the first focal point 4.1.p and the second laser 4.2 or 4.2′ has a second lens for generating the second focal point 4.2.p. The first lens and the second lens each have an identical focal length, in particular of 250 mm to 400 mm. The focusing of the laser beams 4.1.s and 4.2.s is influenced by means of the lenses, which affects the formation of the focal points 4.1.p and 4.2.p with regard to the spatial extent thereof and also the magnitude of the intensity of the laser beams in the region of these focal points 4.1.p and 4.2.p.

Alternatively, it is also conceivable for the first lens and the second lens to have mutually different focal lengths, in particular wherein a value of the focal length of the second lens is then 5% to 10% less than or greater than a value of the focal length of the first lens.

The first analysis laser 4.1, the second laser 4.2 or 4.2′ and the spectrometer 5 are arranged above the trajectory 6 of the objects 2 in accordance with FIG. 2 and FIG. 4 or FIG. 6. Above here is with respect to the gravitational force, which after all also crucially influences the trajectory 6 of the objects 2 as well.

In the preferred configuration, the first analysis laser 4.1, the second laser 4.2 or 22 4.2′ and the spectrometer 5 are arranged below the trajectory 6 of the objects 2. This situation is illustrated in FIG. 1 and FIG. 3 and also FIG. 5 and FIG. 8. The term below is also used here with respect to the gravitational force.

The first analysis laser 4.1 and/or the second laser, in particular the second analysis laser 4.2 or the ablation laser 4.2′, in accordance with FIG. 1 to 6 or FIG. 8, preferably has an alignment device 7. The alignment of the associated lasers 4.1, 4.2 or 4.2′ and thus the location of the associated focal point 4.1.p or respectively 4.2.p is changeable, in particular settable, by means of each alignment device 7. In particular, the spatial arrangement of the two focal points 4.1.p, 4.2.p of the first analysis laser 4.1 and of the second analysis laser 4.2 with respect to one another and in relation to the field of view 5.s of the spectrometer 5 is therefore changeable, settable and/or adaptable. In the preferred embodiment or configuration, the first and second analysis lasers 4.1 and 4.2 are in particular manually aligned or set before operation of the system 1 commences, in particular depending on the expected objects 2 to be analyzed or their expected size and/or anticipated trajectory 6. The above explanations are essentially analogously applicable to FIGS. 5 to 6, in which case here, rather than an analysis laser, an ablation laser 4.2′ is provided as second laser 4.2 and the second focal point 4.2.s of the second laser here does not lie in the field of view 5.s of the open fiber end 5.ofe. In FIG. 7, only first analysis lasers 4.1 are provided, but their focal point 4.1.p lies in the field of view 5.s of the open fiber end 5.ofe of the fiber 5.of, as illustrated in FIG. 7.

An angle between the first laser beam 4.1.s and the second laser beam 4.2.s has 11 a value of less than 30°, in particular less than 20°.

In accordance with the exemplary embodiments from FIG. 1 to FIG. 8, the feeding means 3 is configured in particular as a drivable, in particular flat, conveyor belt 3. The conveyor belt 3 is oriented substantially horizontally, in particular in order to avoid slipping/sliding of the objects 2 during transport on the conveyor belt.

In a very preferred embodiment or configuration, the feeding means 3 is configured as a conveyor belt configured in a substantially flat fashion, as explicitly illustrated e.g. in FIGS. 7 and 8. Particularly with a conveyor belt configured in a flat fashion, a plurality of feeding tracks 10 can also be realized, which should also be explained in even more specific detail below.

Alternatively, the feeding means 3 could also be embodied as a chute. Such a chute is then arranged in an inclined manner, such that the objects 2 move relative to the chute surface on the chute partly in the direction of the gravitational force. Combinations of a conveyor belt and a chute for forming a feeding means 3 are entirely conceivable as well.

Furthermore, a sorting device 8 is now provided and/or present. The objects 2 are sortable on the basis of the measurement data generated by means of the spectrometer 5, in particular depending on an ascertained specific material of the objects 2, into at least two different categories, in particular by means of an air jet. Preferably, the sorting device 8 has a blowing-out nozzle or is embodied as a blowing-out nozzle. The objects are therefore analyzed and, on the basis of the results and the ascertained material of the objects 2 or on the basis of the ascertained material composition of the objects 2, are categorized into different categories and, according to the respective category, are sorted, in some instances in particular then sorted out.

For this purpose, at least one control unit and/or one computer 9 are/is provided and/or present. The control unit 9 and/or the computer 9 are/is effectively connected in terms of control engineering in particular to the feeding means 3, configured as a conveyor belt, for the control and/or regulation thereof. The control unit 9 and/or the computer 9 are/is effectively connected in terms of control engineering to the first analysis laser 4.1 for the control and/or regulation thereof. The control unit 9 and/or the computer 9 are/is effectively connected in terms of control engineering to the second laser 4.2 or 4.2′ for the control and/or regulation thereof. The control unit 9 and/or the computer 9 are/is effectively connected to the spectrometer 5 in terms of control engineering and/or in terms of data technology. By means of the control unit 9 and/or the computer 9, the measurement data generated by means of the spectrometer 5 are evaluable, wherein in particular the respective material of the respective objects 2 is determinable. In particular, the control unit 9 and/or the computer 9 are/is also effectively connected in terms of control engineering to the sorting device 8 for the control and/or regulation thereof. In order to realize the respective effective connections in terms of control engineering and/or in terms of data technology, provision is made of corresponding signal lines and/or data lines, in particular. Signal and/or data transmission via radio, WLAN or Bluetooth is also possible or conceivable.

A first and a second control module 4.1.LM and 4.2.LM are provided and/or present for controlling the first analysis laser 4.1 and for controlling the second laser 4.2 or 4.2′ in accordance with FIGS. 1 to 8, wherein the first analysis laser 4.1 and the second laser 4.2 or 4.2′ are embodied and/or configured as an LIBS system or part of an LIBS system. In the case of the embodiment of the system 1 as illustrated in FIGS. 5 and 6, here a second laser configured as an ablation laser 4.2′ is provided rather than a second analysis laser; otherwise, the explanations given above are analogously applicable.

In this case, the optical fiber 5.of and/or the open fiber end 5.ofe and/or the spectrometer 5 are/is configured and/or embodied in particular also as part of the LIBS system. In this case, the control modules 4.1.LM and 4.2.LM are also part of the control unit and/or of the computer 9 in particular functionally and/or in terms of component engineering. In particular the control unit and/or the computer 9 are/is likewise in particular also configured as part of the LIBS system.

Further detection means 11 are provided and/or present, with the aid of which the geometry and/or size and/or the position of the objects 2 on the feeding means 3 are/is ascertainable. In particular, for this purpose, a corresponding camera system is provided and/or effectively connected in terms of control engineering to the control unit and/or the computer 9.

The explanations given above relate in principle to all the exemplary embodiments shown in FIGS. 1 to 8. It should be pointed out once again at this juncture that FIGS. 1 to 6 essentially show a corresponding system 1 in side view with one feeding track 10 recognizably formed on the feeding means 3. By contrast, FIG. 7 and 8 show, in particular at least partly by way of example, a very preferred embodiment or configuration of the system 1 with a plurality of feeding tracks 10 formed on the feeding means 3, which feeding tracks here indeed in the very preferred embodiment or configuration are not physically and/or mechanically separate from one another, but are configured as “virtual” feeding tracks 10, in particular are now also realized by corresponding separation devices (not illustrated here) arranged over the width of the feeding means 3 being disposed upstream of the feeding means 3. The elucidations or explanations given concerning FIGS. 1 to 6 are therefore analogously applicable, in principle, to the exemplary embodiments in FIGS. 7 and 8 as well. With respect to FIGS. 7 and 8, however, the following is now explicitly stated once again: in particular, it should be pointed out once again that in the case of the exemplary embodiments in FIGS. 7 and 8, not all of the components illustrated in FIGS. 1 to 4, for example, are also explicitly illustrated/depicted, but the corresponding components, for example the sorting device and/or the detection means and also the control unit and/or the computer, etc., are also present or provided in the case of the exemplary embodiments in accordance with FIGS. 7 and 8.

FIG. 8 shows a very preferred embodiment or configuration of the system 1. The feeding means 3 here has a plurality of feeding tracks 10 for feeding and/or conveying the objects 2. As revealed by FIG. 8, the individual feeding tracks 10 are not physically and/or mechanically separate with respect to one another, but rather here in the case of the embodiment illustrated in FIG. 8 are only realized by a plurality of separation devices being arranged at the beginning of the feeding means 3 over the width of the feeding means 3, which here is embodied in particular as a conveyor belt, i.e. here then in a manner distributed over the width. These separation devices are not explicitly illustrated, however, here in FIG. 8. In particular the feeding tracks 10 represented by dashed “lines 10” on the feeding means 3 are then realized as a result. In particular, in the case of the preferred configuration, the conveyor belt 3 is then also configured in a flat fashion here. As further clarified by FIG. 8, each feeding track 10 is assigned a respective first and a respective second analysis laser 4.1 and 4.2. Furthermore, each feeding track 10 is assigned a respective field of view 5.s of a spectrometer 5, in particular here each feeding track 10 is assigned a respective optical fiber 5.of with an open fiber end 5.ofe and/or a respective separate spectrometer 5, although the spectrometers 5 are not specifically illustrated in FIG. 8 (nor in FIG. 7). In particular, here in the case of the preferred configuration of the exemplary embodiments shown in FIGS. 7 and 8, each optical fiber 5.of is then connected to a respective separate spectrometer 5, wherein the spectrometers 5 are in turn connected to the control unit and/or the computer 9 in terms of control engineering and/or in terms of signaling and/or data technology. It is also conceivable, however, for only one spectrometer to be present and then for the optical fibers of the feeding tracks to be connected to this one spectrometer.

The very preferred embodiment of the system 1 as illustrated here in FIG. 8 substantially corresponds to FIG. 1. The explanations given with regard to FIG. 1 are correspondingly analogously applicable to FIG. 8. Furthermore, FIG. 8 shows that the first and second analysis lasers 4.1 and 4.2 illustrated here are arranged adjacent to one another and in this case the respective analysis lasers 4.1 and 4.2 are at a corresponding distance from one another. The same applies to the open fiber ends 5.ofe arranged adjacent to one another. The respective distances between the mutually adjacent first and second analysis lasers 4.1 and 4.2 and the respective distance between the mutually adjacent open fiber ends 5.ofe are in the range of to 200 millimeters, in particular in the range of 50 to 100 millimeters.

In the case of the very preferred exemplary embodiment illustrated in FIG. 8, the sorting device has in particular a plurality of blowing-out nozzles, and is configured in particular as a nozzle strip. Each feeding track 10 is therefore assigned at least one blowing-out nozzle.

By contrast, although FIG. 7, in a manner corresponding to FIG. 8, also shows a feeding means 3 configured in particular as a flat conveyor belt, here only one laser, namely a first analysis laser 4.1, is assigned to each feeding track 10 or arranged for each feeding track 10. An optical fiber 5.of with an open fiber end 5.ofe is also provided for each feeding track 10; a separate spectrometer (not illustrated) is also provided in particular for each feeding track 10. The focal point 4.1.p of the—first—analysis laser 4.1 lies in the field of view 5.s of the optical fiber 5.of, as revealed well by FIG. 7. The explanations given above are essentially applicable to FIG. 7 as well, with the exception that here only one laser, namely an analysis laser 4.1, is provided for each feeding track 10, in which case the method is correspondingly realizable with the corresponding respective components (some of which are not illustrated here) in accordance with the explanations given above.

In the case of a further embodiment or configuration of the system 1, provision can furthermore be made for the objects 2 which are not identifiable or are only inadequately identifiable then to be feedable again to the feeding means 3 with the aid of a return system present (not illustrated in FIGS. 1 to 8). Such a return system has in particular at least one further blowing-out nozzle and/or a further, second nozzle strip and also further conveyor belts, which then ensure that these aforementioned objects 2, in particular at the beginning of the feeding means 3, are concomitantly supplied to the feeding means 3 again, such that these objects 2 then again at the end of the feeding means 3 can be fed into the corresponding measurement region or into the corresponding measurement regions for analysis and/or sorting, as described above.

### LIST OF REFERNCE SIGNS

1 system for analyzing objects
2 objects
3 feeding means, in particular conveyor belt
3.e end of the feeding means 3
4.1 first laser/first analysis laser
4.1.s first laser beam
4.1.p first focal point
4.1.LM control module
4.2 second laser/second analysis laser
4.2′ second laser/ablation laser
4.2.s second laser beam
4.2.p second focal point
4.2.LM control module
5 spectrometer
5.s field of view of the spectrometer 5
5.of optical fiber
5.ofe open fiber end
6 trajectory
7 alignment device
8 sorting device
9 control unit and/or computer
10 feeding track
11 detection means, in particular camera
S perpendicular to the trajectory 6

1-50. (canceled)

51. A method for analyzing objects, the method comprising:
providing at least one feeding device, at least one analysis laser, and at least one spectrometer;
feeding the objects by the feeding device and causing the objects to move along a trajectory from an end of the feeding device for analyzing the objects;
generating a laser beam with a focal point by the analysis laser, with the feeding device and the analysis laser being aligned to cause the objects to fly along the trajectory through the laser beam in a region of the focal point during a respective movement thereof along the respective trajectory;
providing the spectrometer with an optical fiber and realizing a field of view of the spectrometer by an open fiber end of the optical fiber;
aligning the field of view of the spectrometer with a region of the trajectory of the objects, with the focal point of the analysis laser lying in the field of view of the spectrometer, and generating plasmas of the objects at the focal point of the analysis laser; and
spectroscopically analyzing emissions of the plasmas by the spectrometer for analyzing the objects.

52. The method according to claim 51, which comprises capturing the emissions of the plasmas generated at the objects by the analysis laser by way of the open fiber end.

53. The method according to claim 51, wherein the analysis laser is a first analysis laser and the method further comprises providing a second laser for generating a second laser beam with a second focal point, and aligning said second laser with the feeding device in such a way that the objects fly through said second laser beam in the region of the second focal point during a respective movement thereof on the respective trajectory.

54. The method according to claim 53, wherein the second focal point of said second laser lies in the field of view of the spectrometer, wherein said first analysis laser and said second laser are aligned with one another in such a way that the first focal point of said first analysis laser is spaced apart from the second focal point of said second laser, wherein plasmas of the objects are generated by means of the focal point of said first analysis laser and/or by the focal point of said second laser, and wherein emissions of said plasmas are analyzed spectroscopically by the spectrometer, also capturing the emissions of the objects generated by the second focal point by the open fiber end.

55. The method according to claim 54, which comprises aligning said first analysis laser and said second laser with one another in such a way that the first focal point of said first analysis laser and the second focal point of said second laser lie one above another on substantially a perpendicular to the trajectory of the objects.

56. The method according to claim 54, which comprises aligning said first analysis laser and said second laser with one another in such a way that the first focal point of said first analysis laser and the second focal point of said second laser are substantially horizontally adjacent to one another or horizontally spaced apart from one another.

57. The method according to claim 51, wherein the analysis laser is a first analysis laser and the method further comprises providing a second laser for generating a second laser beam with a second focal point, and emitting pulses with a specific pulse repetition rate by the analysis laser and/or by said second laser, wherein a value of the pulse repetition rate in kilohertz (kHz) corresponds to a specific value of a speed of the objects upon leaving the feeding device in meters per second (m/s) multiplied by a specific factor of at least 15, and the first and the second analysis laser have a pulse repetition rate of at least 20 kHz.

58. The method according to claim 51, wherein the analysis laser is a first analysis laser and the method further comprises providing a second laser for generating a second laser beam with a second focal point, wherein at least one of said first analysis laser or said second laser has an alignment device, wherein an alignment of the associated laser and thus the location of the associated focal point are changed as necessary by each alignment device, and wherein the spatial arrangement of the focal points of said first analysis laser and said second laser with respect to one another and in relation to the field of view of the spectrometer is changed.

59. The method according to claim 51, wherein the analysis laser is a first analysis laser and the method further comprises providing a second laser for generating a second laser beam with a second focal point, and the method further comprises:
providing a sorting device and sorting the objects into at least two categories on a basis of the measurement data generated by the spectrometer, in dependence on a determined material of the objects, and thereby sorting by way of an air jet;
providing at least one of a control unit or a computer and controlling the feeding device, being a conveyor belt, by the control unit or the computer;
controlling said first analysis laser by the control unit or the computer, controlling said second laser by the control unit or the computer, and controlling the spectrometer by the control unit or the computer;
evaluating the measurement data generated by way of the spectrometer by the control unit or the computer to determine a material of the respective objects; and
controlling the sorting device by the control unit or the computer to blow out or sort out the respective determined objects.

60. The method according to claim 51, which comprises feeding the respective objects in separated fashion by the feeding device and casting off the objects from the end of the feeding device in separated fashion sequentially one after another.

61. The method according to claim 51, wherein the analysis laser is a first analysis laser and the method further comprises providing a second laser (4.2) for generating a second laser beam with a second focal point, and the method further comprises: providing a first control module and a second control module for controlling said first analysis laser and said second laser, respectively, and configuring at least one of said first analysis laser, said second laser, or the first and/or second control module as an LIBS system or at least as a part of an LIBS system.

62. The method according to claim 61, which comprises providing at least one of the optical fiber, the open fiber end, or the spectrometer as part of the LIBS system.

63. The method according to claim 61, wherein the control modules are embodied functionally or in terms of component engineering as constituent parts of at least one of the control unit or of the computer, and at least one of the control unit or the computer is configured as part of the LIBS system.

64. The method according to claim 59, which comprises providing at least one further detector, being a camera system, configured to ascertain at least one of a geometry, a size, or a position of the objects on the feeding device and effectively connecting the camera system to at least one of the control unit or the computer in terms of control engineering.

65. A system for analyzing objects, the system comprising:
at least one feeding device, at least one first analysis laser, and at least one spectrometer, wherein the objects are fed by the feeding device and, starting from an end of the feeding device, the objects are cast off on a trajectory for an analysis thereof;
said first analysis laser being configured to generate a first laser beam with a first focal point, and wherein said first analysis laser is aligned with said feeding device such that the objects fly through the laser beam in a region of the focal point during a movement of the objects along the trajectory;
said spectrometer having an optical fiber with an open fiber end defining a field of view of said spectrometer that is aligned with a region of the trajectory of the objects, wherein the focal point of said analysis laser is arranged in the field of view of the spectrometer, and wherein plasmas of the objects are generated at the focal point of the analysis laser; and
said spectrometer being configured to spectroscopically analyze emissions of the plasmas with the field of view of the spectrometer defined by said open fiber end of said optical fiber.

66. The system according to claim 65, wherein emissions of the plasmas generated at the objects by the analysis laser are capturable by the open fiber end.

67. The system according to claim 66, wherein a distance between said open fiber end and an end of said feeding device, being a casting-off edge, has a specific value being less than 350 mm, and said open fiber end has a numerical aperture with a value of between 0.14 to 0.28.

68. The system according to claim 67, wherein said optical fiber is a step-index fiber, being a multimode fiber, or said optical fiber has a quartz glass core and a cladding with an outer acrylate cladding and a fluorine-doped intermediate layer.

69. The system according to claim 65, wherein said optical fiber has a core diameter with a value of 50 μm to 700 μm.

70. The system according to claim 65, which further comprises:
a second laser being usable as a second analysis laser, said second laser being configured to generate a second laser beam with a second focal point;
said second laser being aligned with said feeding device such that the objects fly through said second laser beam in a region of said second focal point during a movement along the respective trajectory;
said second focal point of said second analysis laser being arranged in the field of view of said spectrometer;
said first analysis laser and said second analysis laser being aligned with one another in such a way that the first focal point of said first analysis laser is arranged spaced apart from the second focal point of said second analysis laser, wherein plasmas of the objects are generable by at least one of the focal point of said first analysis laser or the focal point of said second analysis laser; and
wherein said spectrometer is configured to spectroscopically analyze the emissions of the plasmas and wherein the plasma emissions of the objects generated by the second focal point are also capturable by the open fiber end.

71. The system according to claim 70, wherein said first analysis laser and said second analysis laser are aligned with one another in such a way that said focal point of said first analysis laser and said focal point of said second analysis laser are arranged one above another substantially perpendicular to the trajectory of the objects.

72. The system according to claim 70, wherein said first analysis laser and said second laser are aligned with one another in such a way that the focal point of said first analysis laser and the focal point of said second laser are arranged substantially horizontally adjacent to one another or horizontally spaced apart from one another.

73. The system according to claim 65, wherein at least one of said first analysis laser or said second laser has a pulse repetition rate, wherein a value of said pulse repetition rate in kHz corresponds to a specific value of a speed of the objects upon leaving the feeding device in m/s multiplied by a specific factor of at least 15.

74. The system according to claim 65, wherein at least one of the first focal point of said first analysis laser or the second focal point of said second laser has a focal point diameter of 0.1 mm to 0.2 mm.

75. The system according to claim 74, wherein said first analysis laser has a first lens for generating the first focal point and said second laser has a second lens for generating the second focal point, and wherein the first lens and the second lens have an identical focal length between 250 mm and 400 mm.

76. The system according to claim 74, wherein said first analysis laser has a first lens for generating the first focal point and said second laser has a second lens for generating the second focal point, wherein the first lens and the second lens have mutually different focal lengths differing from one another by 5% to 10%.

77. The system according to claim 70, wherein said first analysis laser, said spectrometer, and said second laser are arranged above the trajectory of the objects or wherein said first analysis laser, said spectrometer and said second laser are arranged below the trajectory of the objects.

78. The system according to claim 65, wherein at least one of said first analysis laser or said second laser has an alignment device, wherein a alignment of the associated said laser and thus a location of the associated focal point are changeable by each respective alignment device, wherein a spatial arrangement of the focal points of said first analysis laser and said second laser with respect to one another and in relation to the field of view of said spectrometer is changeable, with an angle between the first laser beam and the second laser beam has a value of less than 30°.

79. The system according to claim 65, wherein said feeding device is at least one of a conveyor belt or a chute configured as to transport the objects in a separated transport in a sequential order lined up along a line.

80. The system according to claim 79, wherein said conveyor belt is oriented substantially horizontally or the conveyor belt or the chute is configured to be cross-sectionally V-shaped or curved.

81. The system according to claim 65, further comprising a sorting device configured to sort the objects according to a material on a basis of measurement data generated by the spectrometer, the objects being sortable into at least two different categories by an air jet generated via a blowing-out nozzle.

82. The system according to claim 65, further comprising:
a sorting device configured to sort the objects according to a material on a basis of measurement data generated by the spectrometer;
at least one of a control unit or a computer effectively connected in terms of control engineering to said feeding device, being a conveyor belt;
said control unit or said computer being effectively connected in terms of control engineering to said first analysis laser for controlling said first analysis laser and effectively connected in terms of control engineering to said second laser for controlling said second laser;
said control unit or said computer being effectively connected in terms of control engineering and/or in terms of data technology to said spectrometer, wherein the measurement data generated by said spectrometer are evaluable by said control unit or said computer, and wherein the respective material of the respective objects is determinable; and
said control unit or said computer being effectively connected in terms of control engineering to said sorting device for controlling said sorting device.

83. The system according to claim 82, further comprising first and second control modules for controlling said first analysis laser and said second laser, respectively, wherein at least one of said first analysis laser, said second laser, said first control module, or said second control module is configured as an LIBS system or at least as part of an LIBS system.

84. The system according to claim 83, wherein at least one of said optical fiber or said spectrometer is a part of the LIBS system.

85. The system according to claim 83, wherein at least one of said first or second control modules is embodied functionally and/or in terms of component engineering as part of said control unit or of said computer, and at least one of said control unit or said computer is also configured as part of the LIBS system.

86. The system according to claim 65, which comprises at least one further detector, being a camera system, configured to ascertain at least one of a geometry or a size or a position of the objects fed on the feeding device, and where said camera system is effectively connected to at least one of said control unit or said computer in terms of control engineering.

87. The system according to claim 65, wherein said feeding device has at least one feeding track, or a plurality of feeding tracks that are virtually separate, or a plurality of physically separate feeding tracks, and wherein each feeding track is assigned a respective first and/or a respective second analysis laser and/or an ablation laser and a respective field of view of a spectrometer, and wherein each feeding track is assigned a respective optical fiber with an open fiber end or a respective separate spectrometer.

88. The system according to claim 87, wherein a distance between mutually adjacent first and second analysis lasers, or a distance between mutually adjacent open fiber ends lies in a range of 20 to 200 mm.

89. The system according to claim 87, wherein said sorting device comprises return system and a nozzle strip having a plurality of blowing-out nozzles, wherein each feeding track is assigned at least one blowing-out nozzle, and wherein objects that are not identifiable or are only inadequately identifiable are once more feedable to said feeding device by way of said return system.
